(19) United States
(12) Patent Application Publication
(10) Pub. No.: US 2017/0014945 A1
(43) Pub. Date: Jan. 19, 2017

(54) METHODS AND SYSTEMS FOR LASER MARKING AN IDENTIFIER ON AN INDUSTRIAL PRODUCT

(71) Applicant: LASERAX INC., Quebec (CA)

(72) Inventors: Alex Fraser, Quebec (CA); Xavier Pruneau Godmaire, St-Lambert-de-Lauzon (CA)

(21) Appl. No.: 15/010,206

(22) Filed: Jan. 29, 2016

Related U.S. Application Data
(60) Provisional application No. 62/193,886, filed on Jul. 17, 2015.

(51) Int. Cl. B23K 26/00; B23K 26/03

(52) U.S. Cl. CPC B23K 26/0066; B23K 26/0087; B23K 26/03

(57) ABSTRACT

There is provided a method of laser marking an identifier on an industrial product in a production line. The method generally includes, using a 3D imaging system, generating 3D image data representative of a laser-marking surface of the industrial product in the production line; using a processor, accessing the 3D image data; accessing virtual reference shape data including virtual laser-marking surface data; generating position and orientation data representative of a position and an orientation of the laser-marking surface in the 3D image data based on the virtual reference shape data and the virtual laser-marking surface data; and obtaining identifier data representative of the identifier of the industrial product; and using a laser marker, laser marking the identifier on the laser-marking surface of the industrial product in the production line based on the position and orientation data.

This patent application claims priority of U.S. provisional Application Ser. No. 62/193886, filed on Jul. 17, 2015, the content of which is hereby incorporated by reference.

### FIELD

The improvements generally relate to the production of industrial products, and more particularly to methods and systems which involve laser marking on such industrial products.

### BACKGROUND

The ability of industrial products to be identified and tracked along the manufacturing, transformation and distribution chain is referred to traceability. In case of a failure, actors of the production industry can track down the cause of the failure and react accordingly.

It was known to identify each industrial product produced by a production plant by laser marking an identifier on a surface of the industrial product. Although laser marking techniques were satisfactory to a certain degree, there always remains room for improvement. For instance, in some circumstances, laser-marked identifiers are not satisfactorily readable, which is undesired.

### SUMMARY

Traceability is a consideration for maintaining satisfactory quality standards in a production plant where a flow of industrial products are produced in a production line. Identification of the industrial products can be performed by laser marking.

It was found that one specific need occurs when the production line yields industrial products having laser-marking surfaces which vary from one industrial product to another. In these circumstances, the variability associated with the position, orientation and/or irregularities in the shape of the laser-marking surface of each industrial product can cause laser-marking defects (e.g. an identifier which is not satisfactorily readable).

In accordance with one aspect, there is provided a method for laser marking an identifier on an industrial product in a production line, the method comprising: using a 3D imaging system, generating 3D image data representative of a laser-marking surface of the industrial product in the production line; using a processor, accessing the 3D image data; accessing virtual reference shape data including virtual laser-marking surface data; generating position and orientation data representative of a position and an orientation of the laser-marking surface in the 3D image data based on the virtual reference shape data and the virtual laser-marking surface data; and obtaining identifier data representative of the identifier; and using a laser marker, laser marking the identifier on the laser-marking surface of the industrial product in the production line based on the position and orientation data and on the identifier data.

In accordance with another aspect, there is provided a system for laser marking an identifier on an industrial product in a production line, the method comprising: a 3D imaging system disposed in the production line and being configured for generating 3D image data representative of a laser-marking surface of the industrial product in the production line; a processor configured for accessing the 3D image data; accessing virtual reference shape data including virtual laser-marking surface data; generating position and orientation data representative of a position and an orientation of the laser-marking surface in the 3D image data based on the virtual reference shape data and the virtual laser-marking surface data; and obtaining identifier data representative of the identifier; and a laser marker disposed in the production line and being configured for laser marking the identifier on the laser-marking surface of the industrial product in the production line based on the position and orientation data and the identifier data.

One specific need occurs when the industrial products produced in the production line have laser-marking surfaces which are irregular from one industrial product to another. Indeed, the irregularity associated with each industrial product can be challenging in terms of laser marking because the irregularities prevent a focal spot of the laser-marking beam to satisfactorily follow the laser-marking surface of the industrial product to laser mark.

In accordance with another aspect, there is provided a method for laser marking identifiers on industrial products in a production line of a production plant, the method comprising; conveying a plurality of industrial products to form a flow of industrial products along the production line, the industrial products each having a laser-marking surface, a shape and a position of the laser-marking surface being irregular from one of the industrial products to another; using a 3D imaging system, obtaining 3D image data indicative of the irregular shape and the irregular position of the laser-marking surface of a first one of the industrial products along the flow of industrial products; obtaining identifier data representative of the identifier of the first industrial product; using a laser marker, laser marking the identifier associated with the first industrial product on the laser-marking surface of the first industrial product by displacing a focal spot of a laser-marking beam of the laser marker along irregularities of the laser marking surface based on the 3D image data and the identifier data; and repeating the steps of obtaining and laser marking for other ones of the industrial products.

In accordance with another aspect, there is provided a system for laser marking identifiers on industrial products in a production line of a production plant, the system comprising: a 3D imaging system and a laser marker disposed in the production line and oriented towards a flow of industrial products of the production line, each industrial product having a laser-marking surface having a shape and a position being irregular from one of the industrial products to another; a processor in communication with the 3D imaging system and the laser marker, the processor being coupled with a computer-readable memory being configured for storing computer executable instructions that, when executed by the processor, perform the steps of: obtaining 3D image data indicative of the irregular shape and the irregular position of the laser-marking surface of a first one of the industrial products of the flow of industrial products; obtaining identifier data representative of the identifier of the first industrial product; instructing the laser marker to laser mark the identifier associated with the first industrial product on the laser-marking surface of the first industrial product by displacing a focal spot of a laser-marking beam of the laser marker along irregularities of the laser-marking surface based on the 3D image data and the identifier data.

One other specific need occurs when an industrial product has a laser-marking surface which has defects (e.g. spots, surface irregularities) thereon. In this situation, it was found that laser marking the identifier onto one or more defects of the surface can yield unreadable identifiers. For instance, in a particular situation, spots can prevent a laser-marked identifier to exhibit a satisfactory contrast with its surrounding, which limits readability of the identifier. In another particular situation, surface irregularities such as roughness, cracks, holes, or other sources of distance variations between the surface and the beam source as the surface is being marked can prevent a laser marker to suitably laser mark the surface of the industrial product, which also limits readability of the identifier.

In accordance with another aspect, there is provided a method for laser marking an identifier on a surface of a piece of material based on at least image data of at least a portion of the surface, the method comprising the steps of: analyzing at least a first portion of the at least image data for at least one imaged defect, the first portion corresponding to a first area of the surface; upon determining the presence of an imaged defect in the first portion, analyzing at least a second portion of the at least image data for at least one imaged defect, the second portion corresponding to a second area of the surface; and laser marking the identifier on the second area upon determining the absence of an imaged defect in the second portion of the at least image data.

In accordance with another aspect, there is provided a system for laser marking an identifier on a piece of material, the system comprising: a camera mounted to a first frame and oriented towards at least a portion of a surface of the piece of material; a laser marker mounted to a second frame and adapted to provide a laser-marking beam towards the at least a portion of the surface of the piece of material; and a processor in communication with the camera and with the laser marker, the processor being coupled with a computer-readable memory being configured for storing at least image data received from the camera and computer executable instructions that, when executed by the processor, perform the steps of: analyzing at least a first portion of the at least image data for at least one imaged defect, the first portion corresponding to a first area of the surface; upon determining the presence of an imaged defect in the first portion, analyzing at least a second portion of the at least image data for at least one imaged defect, the second portion corresponding to a second area of the surface; and instructing the laser marker to laser mark the identifier on the second area upon determining the absence of an imaged defect in the second portion of the at least image data.

In accordance with another aspect, there is provided a method for laser marking an industrial product, the method comprising the steps of: receiving, from a camera, an image of a surface of the industrial product; determining if a given area of the image comprises an imaged defect corresponding to an actual defect of the surface of the industrial product; and generating laser-marking instructions based on said determination.

Many further features and combinations thereof concerning the present improvements will appear to those skilled in the art following a reading of the instant disclosure.

### DESCRIPTION OF THE FIGURES

In the figures,

FIG. 1 is a schematic view of a production line along which industrial products are produced and identified at a laser-marking station, in accordance with an embodiment;

FIG. 2 is an example of an identifier laser marked on an industrial product of the production line of FIG. 1, in accordance with an embodiment;

FIG. 3A is a partial and oblique view of the laser-marking station shown in FIG. 1;

FIG. 3B is a block diagram of an example of a system for laser marking an identifier that is part of the laser-marking station shown in FIG. 1, in accordance with an embodiment;

FIG. 4 is a flowchart of an example of a method for laser marking an identifier on an industrial product in the production line of FIG. 1, in accordance with an embodiment;

FIG. 5A is a schematic representation of surfaces of the industrial product shown in FIG. 3A based on 3D image data, in accordance with an embodiment;

FIG. 5B is a schematic representation of a virtual reference shape having a virtual laser marking surface associated with the industrial product shown in FIG. 3A based on virtual reference shape data, in accordance with an embodiment;

FIG. 5C is a schematic representation of FIG. 5A where the virtual laser marking surface shown in FIG. 5B is positioned on the industrial product based on virtual reference shape data and on position and orientation data, in accordance with an embodiment;

FIG. 6 is a flowchart of an example of a method for laser marking an identifier on an industrial product, in accordance with an embodiment;

FIG. 7A is a partial top elevation view of an example of a portion of a surface of an industrial product, in accordance with an embodiment;

FIG. 7B is an example of a first portion corresponding to a first area of the surface shown in FIG. 7A, in accordance with an embodiment;

FIG. 7C is an example of a second portion corresponding to a second area of the surface shown in FIG. 7A, in accordance with an embodiment;

FIG. 8A is a partial, cross-sectional and enlarged view of an example of a surface of an industrial product, in accordance with an embodiment;

FIGS. 8B-C are examples of surface profiles of the surface shown in FIG. 8A, showing two different laser-marking paths, in accordance with two different embodiments; and

FIG. 9 is a schematic view of an example of a system for laser marking an identifier, showing a plant managing system, in accordance with an embodiment.

These figures depict example embodiments for illustrative purposes, and variations, alternative configurations, alternative components and modifications may be made to these example embodiments.

### DETAILED DESCRIPTION

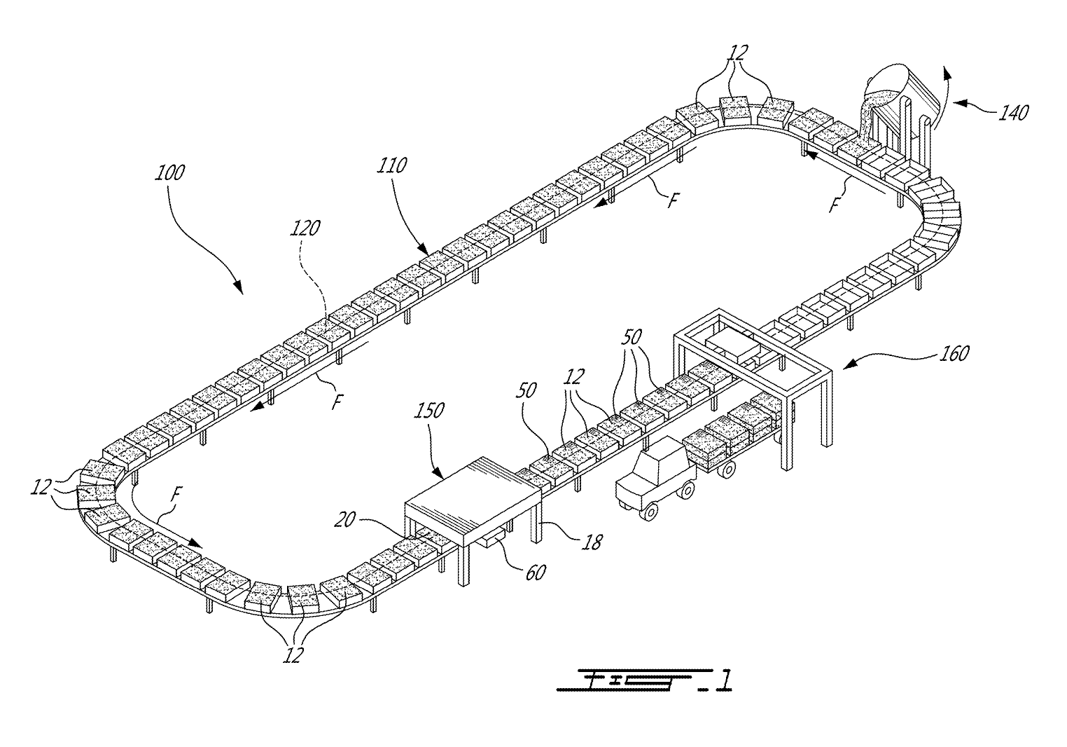

FIG. 1 shows an example of a production plant 100 having a production line 110 used for the production of a flow F of industrial products. The production line 110 has a conveyor path 120 along which each industrial product is produced at a series of successive stations. In this example, the industrial products are in the form of aluminum sows, and empty molds are conveyed at a pouring station 140 where molten metal is poured successively into each of the empty molds to form a flow F of industrial products 12. The freshly poured industrial products are allowed to cool before arriving at a laser-marking station 150 where each industrial product is laser marked an identifier 50 on a laser marking surface 20 thereof. Once each industrial product is suitably cooled and laser marked, it is conveyed along the conveyor path 120 towards a transportation station 160. In this example, the transportation station 160 includes a lift which can pick and place each industrial product on transportation means in order for a batch of industrial products to be transported at another location of the production plant 100.

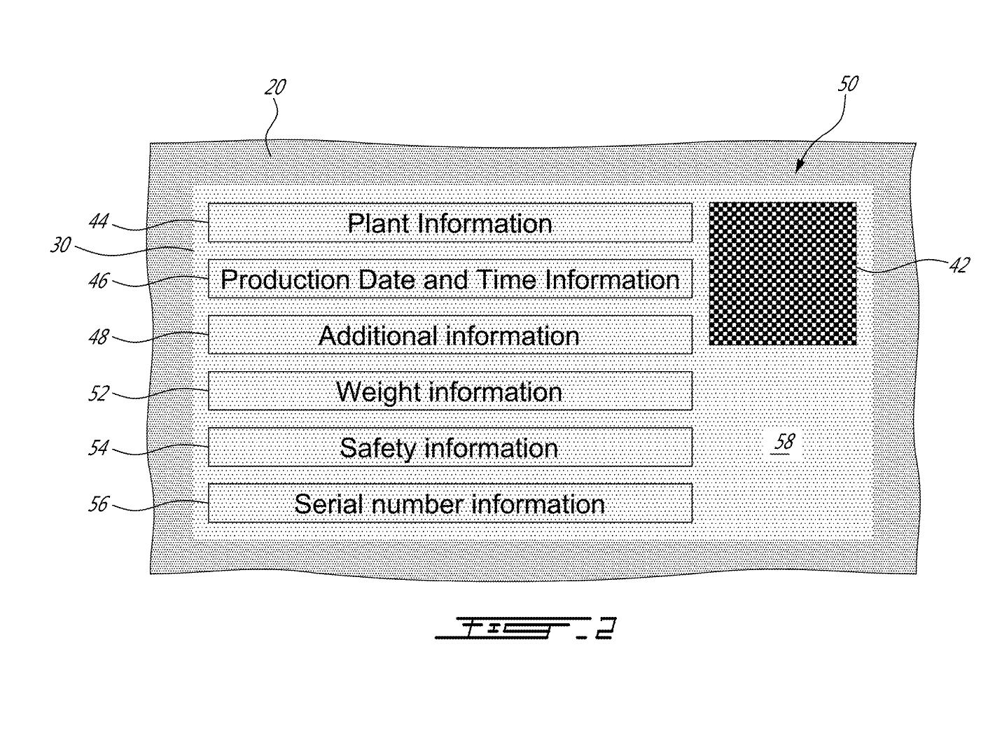

FIG. 2 shows an example of an identifier 50 which is adapted to be laser marked on the laser marking surface 20 in the specific case where the industrial product is an aluminum sow. As illustrated, the identifier 50 has a readable code 42 which allows identification and tracking of the industrial product 12. In the embodiment shown, the identifier 50 also has plant information 44, production date and time information 46, additional information 48 such as weight information 52, safety information 54 and serial number information 56.

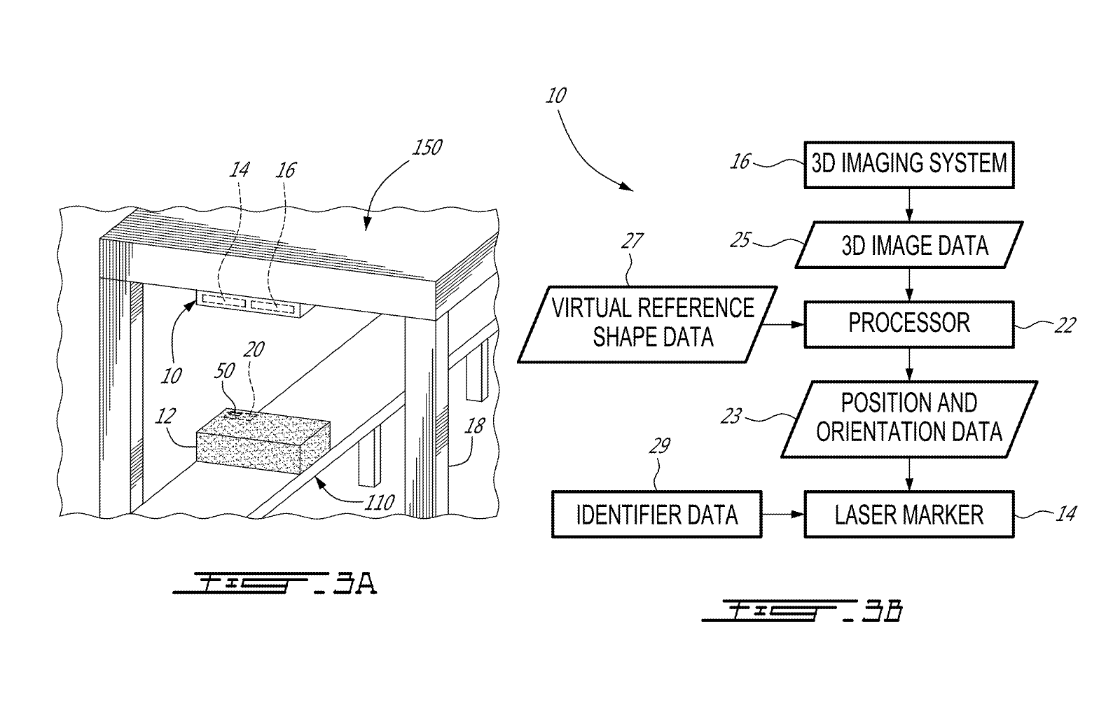

FIG. 3A shows a portion of the laser-marking station 150 shown in FIG. 1. As depicted, the laser-marking station 150 has a frame 18 to which is mounted a system for laser-marking an identifier 50 on an industrial product 12 (simply referred to as “system 10”). Broadly stated, the system 10 generally allows, using computer vision and processing, automated laser marking of identifiers 50 on the flow of industrial products 12 as they are conveyed along the production line 110. It will be noted here that the expressions “convey” or “conveyed”, as used herein, are not intended to imply the presence of a conveyor. Indeed, in alternate embodiments, the industrial products can be conveyed by other means than a conveyor, such as by a robot, for instance.

As shown, the system 10 has one or more laser markers (referred to as “laser marker 14”) and one or more imaging systems (referred to as “imaging system 16”) disposed along the production line 110 and oriented towards a laser-marking surface 20 of the industrial product 12. In this embodiment, the imaging system 16 is a 3D imaging system adapted to obtain 3D images. It will be understood that in alternate embodiments, a 2D imaging system can be satisfactory. As shown, the laser marker 14 and the imaging system 16 can be both mounted to a common frame 18, for instance.

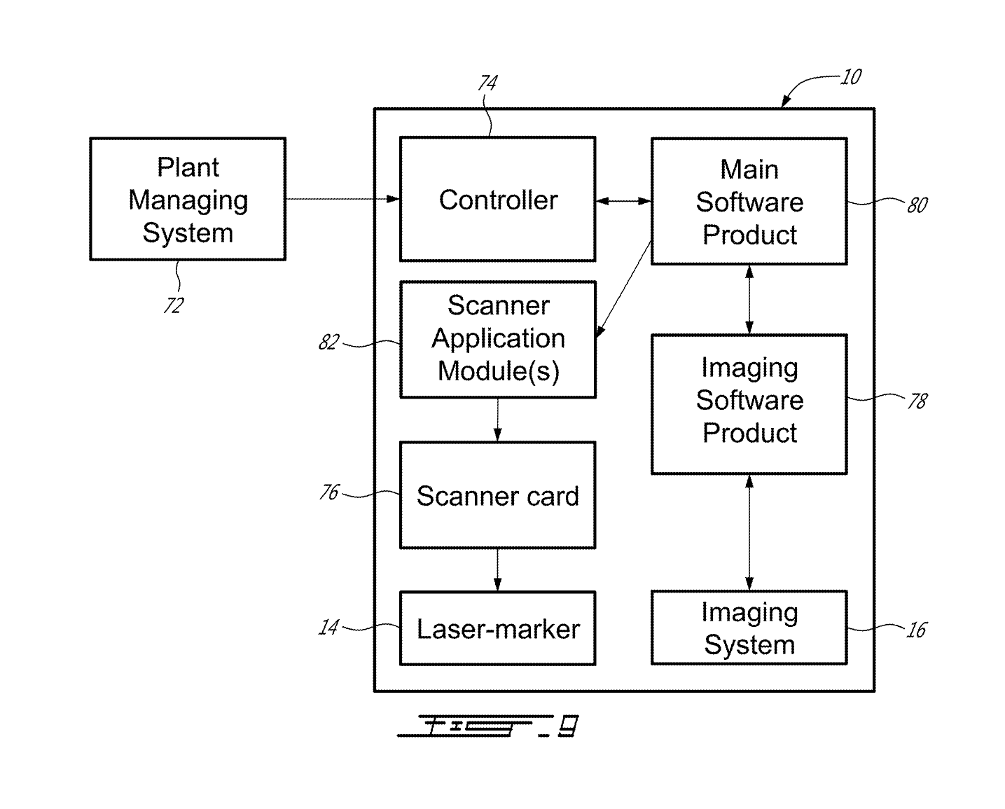

It is envisaged that the system 10 has a processor 22 (see example shown in FIG. 3B) in direct or indirect communication with the laser marker 14 and the imaging system 16. The system 10 can have one or more components of computer-readable memory (referred to as “memory” hereinafter), not shown, for storing data accessible by the laser marker 14, the imaging system 16 and/or the processor 22. The memory can receive identifier data representative of an identifier 50, for instance. The laser marker 14 can access the memory to retrieve the identifier data that is to be laser marked on the laser marking surface 20 to form the identifier 50. The memory can have computer executable instructions which, when executed by the processor 22, perform steps allowing laser marking of the industrial product 12. It is understood that captured images have image data storable on the memory that are accessible by the processor 22. It is noted that the memory can be part of a plant managing system 72 (see FIG. 9) and/or be part of the system 10, depending on the embodiment.

The system 10 is of particular importance in situations where the surface 20 to laser mark is not exactly the same from one industrial product 12 to another. For instance, in the example shown in FIG. 1, industrial products 12 are produced along the production line 110. Even if designed to be accurate and repetitive to some extent, the production line 110 may not be sufficiently accurate and as repetitive to allow satisfactory laser marking using conventional laser markers and methods. Satisfactory laser marking implies that a focal spot of a laser-marking beam coincides with the surface 20 of the industrial product 12 to laser mark during the laser-marking process. However, since the production line 110 is not designed to produce a flow F of industrial products 12 which respects tight tolerances (e.g. tolerance of the order of a dimension of the focal spot of the laser-marking beam), the use of conventional laser markers and methods can lead to poorly marked and/or unreadable identifiers. Indeed, some conventional laser markers and methods operated relative to a predetermined laser marking plane. For instance, in the context of a production line such as the one shown at 110 in FIG. 1, any industrial product 12 having a position that differs from 3 mm or more relative to a predetermined laser marking plane (along the conveyor path 120) is likely to be unsatisfactory laser marked by a given laser marker. Therefore, there is provided systems and methods which at least partially address an issue associated with the variability and/or irregularity of the industrial products produced along such production lines in the context of laser marking.

In an aspect, referring now to FIG. 3B, the system 10 is configured to determine, position and orientation data 23 of a laser-marking surface 20 of each of the industrial products 12. This determination is based on a 3D image including the laser-marking surface 20, obtained with the 3D imaging system 16 when a specific industrial product is in the laser-marking station 150 of the production line 110. A processor runs an artificial vision algorithm on the 3D image data to establish the actual position and orientation of the laser marking surface in the 3D image. The expression position and orientation data 23 is used herein to refer to the data which includes information pertaining to the actual position and orientation of the laser marking surface with the coordinates from the 3D image. More specifically, the algorithm will typically use data concerning a virtual reference shape pertaining to a generally known reference shape of industrial product which appears in the 3D image. The algorithm will proceed to match the virtual reference shape data with the actual shape data in the 3D image. Using the position and orientation data 23 of the laser-marking surface 20, the laser marker 14 can be used to laser mark an identifier 50 directly on the laser-marking surface 20 of each industrial product 12 using the determined position and orientation data 23.

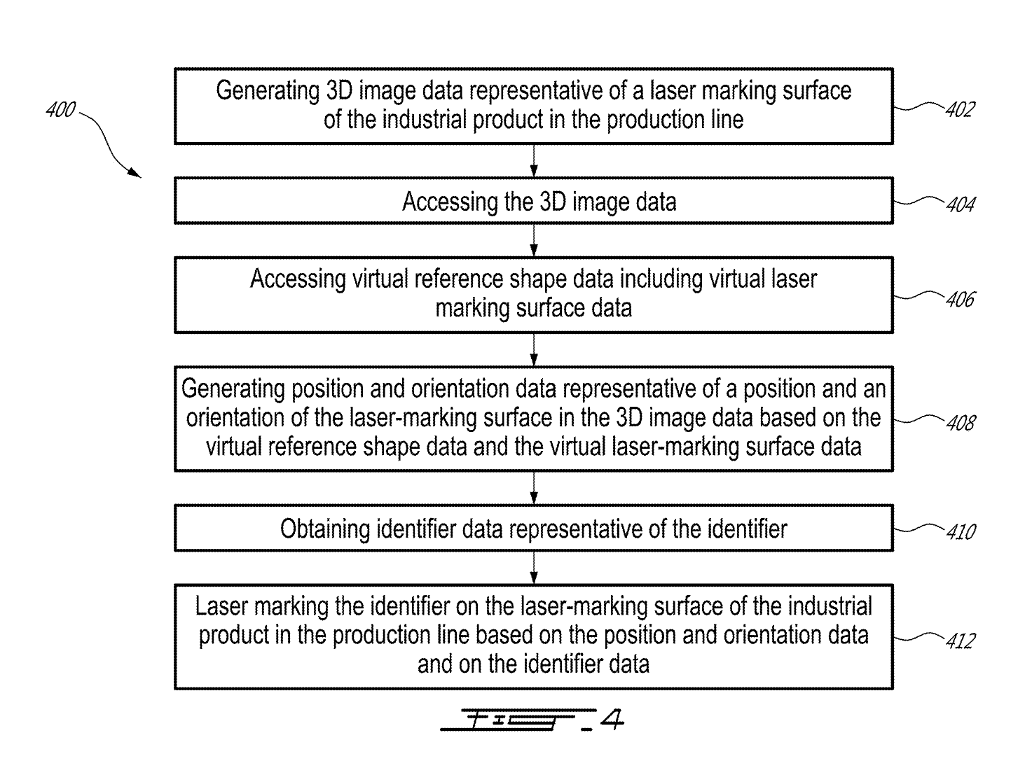

FIG. 4 shows a flowchart of a method 400 to laser mark an identifier 50 on an industrial product 12, in accordance with an embodiment. The method 400 can be performed by the system 10. More specifically, the method 400 has a step 402 of generating 3D image data 25 representative of a laser-marking surface 20 of the industrial product 12 in the production line 110 using the 3D imaging system 16. The 3D image data 25 can be stored on a memory. Once the 3D image data 25 is generated for a given industrial product 12, the method has steps 404, 406 and 408 that can be performed by the processor 22 of the system 10. For instance, the step 404 includes accessing the 3D image data 25 (that can be stored on a memory), the step 406 includes accessing virtual reference shape data 27 including virtual laser-marking surface data (that can be stored on a memory), and the step 408 includes generating the position and orientation data 23 representative of a position and an orientation of the laser-marking surface 20 in the 3D image data 25 based on the recognition of at least a portion of the virtual reference shape data 27 and the virtual laser-marking surface data. The position and orientation data 23 can be stored on a memory. The method 400 has a step 410, that can be performed by the processor 22 of the system 10, of obtaining identifier data 29 representative of the identifier 50 to laser mark on a given industrial product 12. The method 400 also has a step 412, that can be performed by the laser marker 14, of laser marking the identifier 50 on the laser-marking surface 20 of the industrial product 12 in the production line 110 based on the position and orientation data 23 and on the identifier data 29 using the laser marker 14.

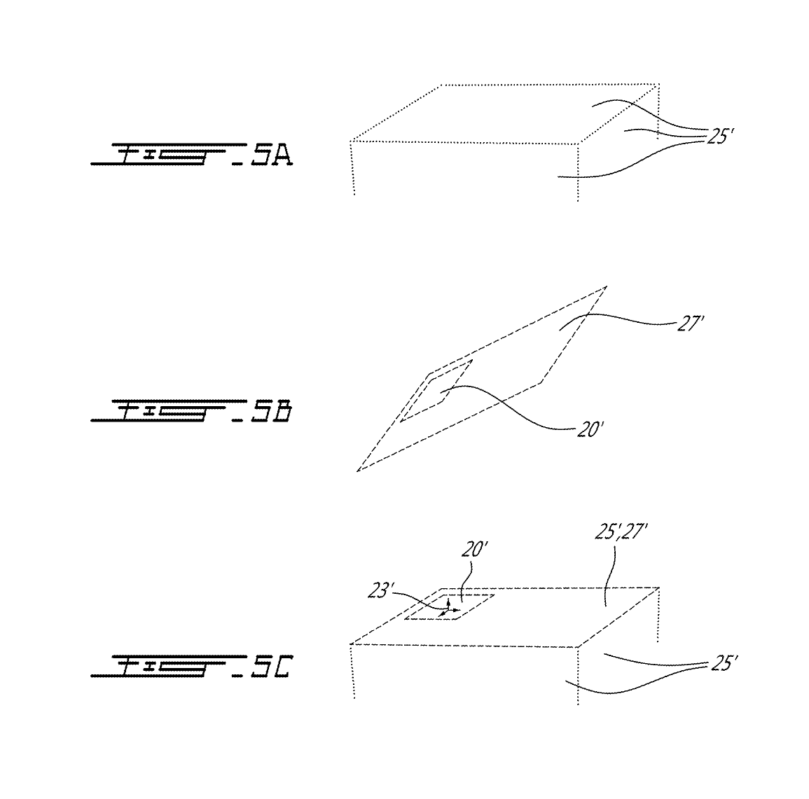

In an embodiment, the virtual laser-marking surface data 27 is representative of a planar laser-marking surface. For instance, if a series of industrial products 12 (e.g. aluminium sows or billets) are produced in the production line 110, the system 10 can use the 3D image data 25 to determine the position and orientation of the laser-marking surface 20 on which to laser mark the identifier 50 based on the virtual reference shape data 27 and the virtual laser-marking surface data. To illustrate this, reference is now made to FIGS. 5A-C.

For instance, FIG. 5A shows a representation of surfaces 25′ of the industrial product 12 shown in FIG. 3A based on the 3D image data 25 captured by the 3D imaging system 16 whereas FIG. 5B shows representations of a virtual reference shape 27′ and a virtual laser marking surface 20′ associated with the industrial product 12 shown in FIG. 3A based on the virtual reference shape data 27. As can be seen, the representations of the virtual reference shape 27′ and the virtual laser marking surface 20′ can have a position and an orientation that differ from that of the surfaces 25′ of the industrial product 12 in the 3D image data. Accordingly, in step 408 of the method 400, the processor 22 is configured to determine the position and orientation data 23 representative of the position and the orientation of the laser-marking surface 20 in the 3D image data 25 that make the virtual reference shape 27′ match with a corresponding one of the surfaces 25′ of the industrial product 12. For instance, FIG. 5C shows a representation of the surfaces 25′ of FIG. 5A based on the 3D image data 25 where the virtual reference shape 27′ has been matched with one of the surfaces 25′ of the industrial product 12 based on the virtual reference shape data 27. Now, it is understood that the position and orientation 23′ of the laser-marking surface 20 can be determined because the position and orientation of the virtual laser marking surface 20′ is known relative to the matched one of the surfaces 25′. It is understood that the virtual reference shape data 27 can include representations of a plurality of virtual reference shape and virtual laser marking surfaces and that the processor 22 is to recognize a given one of the virtual reference shape based on the 3D image data 25.

In another embodiment, the virtual reference shape data 27 can be representative of a plurality of virtual reference shapes such that the position and orientation data are generated upon recognition of one of the plurality of virtual reference shapes (e.g. a bolt of a first type, a bolt of a second type, a bolt of a third type, a nut, etc.) in the 3D image data 25 based on the virtual reference shape data 27 and the virtual laser-marking surface data of the recognized virtual reference shape. For instance, if a bolt of a first type is recognized in the 3D image data 25, the system 10 can, based on the virtual reference shape data 27, determine what are the coordinate data of the recognized bolt and, based on the virtual laser-marking surface data, determine what are the coordinate data of the laser-marking surface 20 of the recognized bolt in the 3D image data 25. Based on such determinations, an identifier 50 indicating that the recognized bolt is a bolt of the first type can be laser marked on the laser-marking surface 20 of the bolt based on the determined coordinate data, for instance.

It is understood that the virtual reference shape data 27 and/or the virtual laser marking surface data can be representative of a planar reference shape (e.g. a 2D shape such as a circle, a rectangle, a parallelogram, etc.) or a 3D reference shape, depending on the embodiment. Examples of 3D reference shape can be a regular 3D shape such as a cube, a pyramid, a sphere and the like, but it can also be another type of 3D shape such as a bolt, a nut, or the shape of any industrial part that can be produced in a production line.

Referring back to FIG. 2, it can be seen that the second area 30 is whitened (e.g. laser whitened) to provide a whitened area 58 such that, when the identifier 50 is laser marked on the whitened area 58, the laser-marked identifier 50 has a contrast relative to the remainder of the second area 30. The expression “whiten” is used here to mean that the surface 20 is laser processed in a manner that changes the gray level of surface. Accordingly, the whitened area 58 will have a gray level higher than the gray level of the laser-marking surface 20 of the industrial product 12. In an embodiment, the step of whitening can be performed prior to the step of laser marking the identifier 50. In another embodiment, the step of whitening is performed after the step of laser marking the identifier 50. Indeed, in this embodiment, the system 10 is configured for laser whitening the surface to the adjacent already laser-marked identifier 50, between empty spaces thereof. The laser-whitening step is optional.

In another aspect, the system 10 images the laser-marking surface 20 of the industrial product 12 such that one or more image data sets (referred to as “image data”) of the laser-marking surface 20 are captured and analyzed to determine whether a given area is suitable for laser marking, and if not, to determine another “defect-free” area where laser marking is likely to provide a laser-marked identifier which is readable. By doing so, situations where an identifier is laser marked on a flawed area of the laser-marking surface 20 of the industrial product 12 can be avoided. In this embodiment, the imaging system 16 of the system 10 can be a 2D imaging system and/or a 3D imaging system.

Once the identifier 50 is laser marked on the industrial product 12, the system 10 can be used to generate post-marking 3D image data representative of the laser-marked surface (and the laser-marked identifier) of the industrial product 12 in the production line 110. The post-marking 3D image data can be analyzed, using the processor 22, to validate if whether the laser-marked identifier is satisfactory or not, and, if not, to generate instructions to correct the laser-marked identifier with an additional step of laser-marking.

An exemplary method that can be used to validate whether if the laser-marked identifier is satisfactory or not relates to a marking depth value associated with the laser-marked identifier. As will be understood, the energy delivered by the laser-marking beam in the step of laser marking causes ablation of material of the industrial product 12 thus creating a recessed channel having the shape of the identifier 50 (referred to as the laser-marked identifier) and being characterized by a given marking depth value. The marking depth value of the laser-marked identifier can be determined by the processor 22 using the post-marking 3D image data. Therefore, the laser-marked identifier can be deemed satisfactory or not based on a comparison of the marking depth value of the laser-marked identifier to a marking depth tolerance value. The marking depth tolerance value can vary from one production line to another. An example of the marking depth tolerance value can be five thousandths of an inch, or 1 thousandth of an inch, for instance, depending on the application.

More specifically, if it is determined that the marking depth value is greater than or equal to the marking depth tolerance value, the laser marking can be said to be satisfactory. However, if the marking depth value is determined to be smaller than the marking depth tolerance value, the laser marking can be said to be unsatisfactory, in which case the processor 22 can be configured to generate a signal. This signal can be provided in the form of instructions to correct the laser-marked identifier with one or more laser-marking corrections where necessary to render the laser-marked identifier satisfactory.

In an alternate example, a determined marking depth value being greater than a minimum depth tolerance value can be considered unsatisfactory. For instance, if the determined marking depth value exceeds a predetermined maximum marking depth, the marking depth value can be determined to be unsatisfactory. In a scenario where satisfactory marking depths are expressed in terms of a depth value + or − a tolerance value (e.g. 0.005″±0.001″), determined depth values can be considered to be unsatisfactory if they are outside the tolerance (e.g. <0.004″ or >0.006″).

In an embodiment, the marking depth value is provided in the form of a plurality of marking depth values each associated with a different portion of the laser-marked identifier.

For instance, the comparison is performed for each one of the marking depth values so that the correction of the laser-marked identifier can be limited to the portion(s) where the marking depth value(s) is(are) smaller than the marking depth tolerance value. In another embodiment, the marking depth value is provided in the form of an averaged marking depth value representing the average of the plurality of marking depth values. In this case, the comparison is performed for the averaged marking depth value and the correction of the laser-marked identifier includes repeating said step of laser marking the identifier 50 onto the already unsatisfactorily laser-marked identifier.

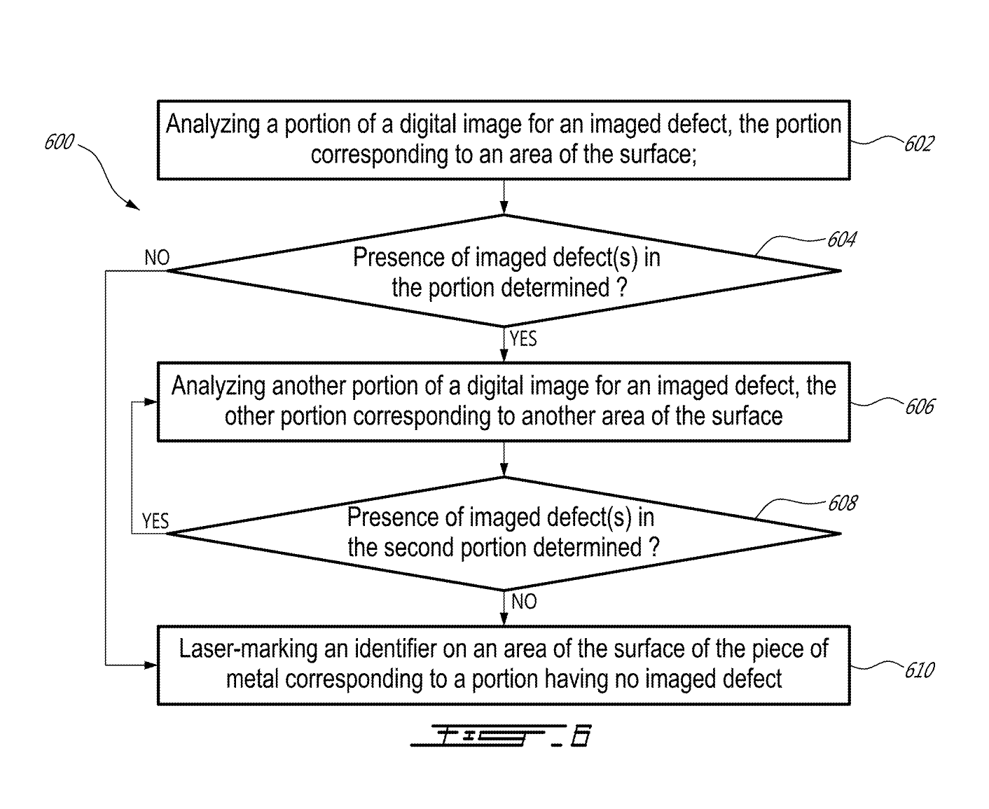

FIG. 6 shows a flowchart of an example of a method 600 for laser marking an identifier 50 on an industrial product 12, in accordance with an embodiment. It is noted that the method 600 can be performed by the system 10 shown in FIG. 3B or by a similar system, for instance, a system 10 having a 2D imaging system.

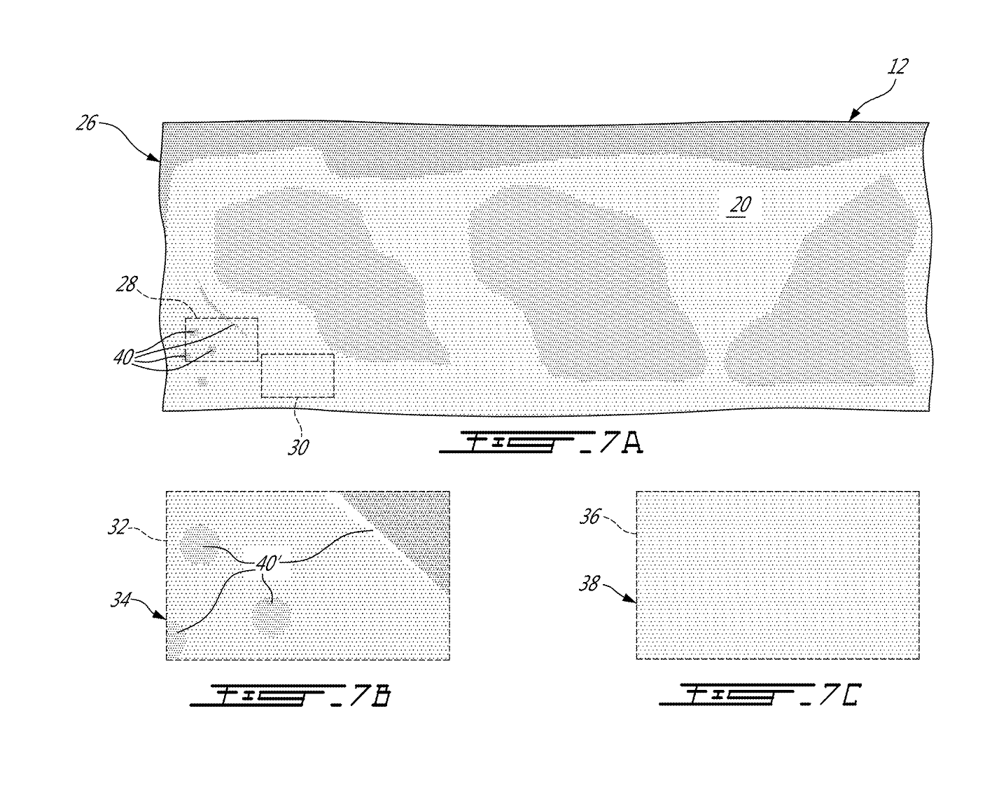

For ease of reading, the steps 602, 604, 606, 608, and 610 of the method 600 will be described with reference to FIGS. 7A-C. More specifically, FIG. 7A shows a portion 26 of a laser-marking surface 20 of an industrial product 12 as well as the first and second areas 28, 30, FIG. 7B shows a first portion 32 of a first image data set 34 which images the first area 28, and FIG. 7C shows a second portion 36 of a second image data set 38 which images the second area 30. As shown, the first area 28 has four defects 40 (three holes and a fissure). Accordingly, the first portion 32, shown in FIG. 7B, has also four imaged defects 40′ corresponding to the four defects 40 shown in FIG. 7A. In the illustrated embodiment, the second area 30 and the second portion 36 comprise no defects and no imaged defects, respectively. It is understood that the surface of the industrial product can be identified based on a recognition of a reference feature of the industrial product in the image data. In this embodiment, the reference feature can be a known portion of the industrial product to laser mark such as a known corner of a known edge. Depending on the embodiment, the first image data set 34 and the second image data set 38 can be captured by two different imaging systems. Further, it will be understood that the first image data set 34 and the second image data set 38 can be provided in the form of a single image data set in which a portion corresponds to the first portion 32, and another portion corresponds to the second portion 36. In this embodiment, the first portion 32 corresponds to a field of view of the imaging system 16 so that the first image data set 34 corresponds to a digital image of the portion 26 of the laser-marking surface 20, and the second portion 36 corresponds to a smaller portion of the first image data set 34.

In an embodiment, dimensions of the first and second portions 32,36 correspond to dimensions of the identifier that is to be laser marked on the laser-marking surface 20 of the industrial product 12. In another embodiment, the first portion 32 is associated with an area of the laser-marking surface 20 which is greater than an area associated with the second portion 36. In this embodiment, it can be useful to analyze a greater area such that positions of defects 40 are identified in order to carefully select the position of the second portion 36. For instance, the first portion 32 which is analyzed for imaged defects 40′ can correspond to an enlarged area of the laser-marking surface 20 of the industrial product 12 while the second portion 36 can be selectively chosen so as to be a “defect-free” area based on the analysis of the enlarged area. In another embodiment, the first portion 32 is a default portion (i.e. the spatial position of the default portion remains the same for each industrial product). In this embodiment, the second portion 36 is chosen to be near the already analyzed default portion. Once defects 40 are identified in the first area 28 of the surface 20, the system 10 can store the positions of the defects 40 so as to select the position of the second area 30 to analyze accordingly.

Still referring to FIG. 6 and to FIGS. 7A-C, the method 600 includes a step 602 of analyzing the first portion 32 of the first image data set 34 for one or more imaged defects 40′ (referred to as “imaged defect 40”). The imaged defect 40′ corresponds to an actual defect 40 of the laser-marking surface 20 of the industrial product 12. Identification of the imaged defect 40′ in a digital image will be detailed further below. The method 600 also has a step 604 of determining the presence of an imaged defect 40′ in the first portion 32. If the first portion 32 has no imaged defect 40′, the method 600 allows, at step 610, laser marking of the identifier on the first area 28 of the laser-marking surface 20 of the industrial product 12. If the presence of an imaged defect 40′ is determined, the method 600 has a step 606 of analyzing another portion, in this case the second portion 36, for an imaged defect 40′. The method 600 has also a step 608 of determining the presence of an imaged defect 40′ in the second portion 36. There again, if the second portion 36 has no imaged defect, the method 600 allows, at step 610, the laser marking of the identifier on the second area 30. If the presence of an imaged defect 40′ in the second portion 36 is determined, the method 600 returns to step 606 where another portion, e.g. a third portion (not shown), is analyzed for an imaged defect 40′ and so forth. As can be seen from FIG. 7C, the second portion 36 has no imaged defects, accordingly, the method 600 will laser mark the identifier on the second area 30, which is likely to yield a satisfactorily readable identifier.

In another embodiment, the method 600 has a validation process which can be performed once the step 610 of laser marking the identifier is performed. This validation process has a step of reading the laser-marked identifier (e.g. with the imaging system 16), a step of validating that the laser-marked identifier is readable and a step of generating a signal based on said validation. In the case where the generated signal indicates that the laser-marked identifier is not satisfactorily readable, the method 600 can also perform a step of correcting the laser-marked identifier. In this embodiment, the system 10 is configured to determine corrections which can render the laser-marked identifier identifiable. Once these corrections are determined, the method 600 has a step of laser marking the corrections on the already laser-marked identifier.

It is understood that algorithms used for the analysis of the image data for defects can include image processing. Accordingly, modifying the contrast of the image data or using imaging techniques such as thresholding or segmenting can be used. In this embodiment, the defects 40 are generally provided in the form of spots (marks differing in color or texture from the laser-marking surface 20 around it) or surface irregularities (e.g. depressions, fissures, holes).

When analyzing 2D image data, the imaged defect 40′ (corresponding to actual defects 40 of the laser-marking surface 20) are generally discernable by a change in gray level, such as shown in FIG. 37. In other words, the imaged defects 40′ can be identified by comparing a gray level of each pixel to a gray level threshold. Accordingly, an imaged defect 40′ is determined when one pixel, or more than one adjacent pixels, has a gray level lower than the gray level threshold (e.g. the gray level “0” can correspond to black while the gray level “255” can correspond to white).

When analyzing 3D image data, defects such as surface irregularities can be identified by their relative depth. In this embodiment, the 3D image data can provide a surface profile of the first and second areas 28, 30 of the laser-marking surface 20 of the industrial product 12. Accordingly, a surface irregularity can be identified when one or more adjacent pixels of the 3D image data are associated with a depth which is greater than a given depth threshold with respect to a reference level. In another embodiment, a surface irregularity can also be identified when one or more adjacent pixels of the 3D image data are associated with a height which is greater than a given height threshold with respect to the reference level. In still another embodiment, the reference level can be provided by fitting a reference surface onto a 3D imaged surface of the industrial product 12. It is noted that defects such as spots can also be identified using gray levels in the 3D image data, for instance. In an embodiment, a given area can be deemed proper for laser marking upon determining that the given area has a flatness mean value below a predetermined flatness threshold value. For instance, the flatness mean value associated with the given area can be obtained based on a statistical analysis of the values associated with each pixel comprised within the given area. Example of statistical analysis can involve determination of a room mean square (RMS) value, a mean value, a value indicating a standard deviation from the mean value, or any suitable statistical means. Accordingly, if the flatness mean value associated with the given area is higher than the predetermined flatness level, it is determined that laser marking is not likely to be satisfactory so another area should be analyzed.

Referring back to FIG. 1 and FIG. 3A, the system 10 can have an optional weight sensor 60 provided in the production line 110, in accordance with an embodiment. In this example, as the industrial product 12 is received on the weight sensor 60 at the laser-marking station 150, the system 10 initiates the steps of analyzing 602, 606 and laser marking 610 while, in the meantime, the weight sensor 60 suitably measures a weight associated with the industrial product 12. Once the weight is measured, possibly during completion of the laser marking of the identifier, the system 10 is adapted to laser mark the so measured weight information 52 associated with the measured weight of the industrial product 12. Other additional information can be measured, or simply obtained, during the steps of analyzing the laser-marking surface 20 and laser marking the identifier. Other additional information will be apparent for the skilled reader.

In an embodiment, the frame 18 is mounted over, to or next to a conveyor of the production line 110 which conveys a flow of industrial products 12 towards the system 10 for laser marking a respective identifier 50 to each one of the industrial products 12. The flow of industrial products 12 along the conveyor path can be continuous, intermittent, regular and/or irregular. The steps of analyzing and laser marking can be performed while the industrial product 12 is immobile, or moving, depending on the application.

In still another aspect, the system 10 images the laser-marking surface 20 of the industrial product 12 to obtain 3D image data indicative of a shape and a position of the laser-marking surface 20 of the industrial product 12. The laser marking surface 20 can vary and be irregular from one industrial product to another, the shape and the position are thus said to be irregular. In this embodiment, the system 10 uses a 3D imaging system 16 to obtain the 3D image data indicative of the irregular shape and the irregular position of the laser-marking surface 20 of a first industrial product along the flow F of industrial products 12. The processor 22 of the system 10 obtains identifier data representative of the identifier to be laser marked on the first industrial product. Using the laser marker 14, the system 10 laser marks the identifier 50 associated with the first industrial product on the laser-marking surface 20 of the first industrial product by displacing a focal spot of a laser-marking beam of the laser marker 14 along irregularities of the laser-marking surface based on the 3D image data and the identifier data. The system 10 can be used repetitively to laser mark each industrial product of the flow F during use.

By doing so, an identifier laser marked on a surface irregularity of the surface of the industrial product can still be readable. It is understood that the movement of the focal spot can include movements that are greater than an effective working distance of the laser-marking beam based on the surface profile of the surface of the industrial product to allow satisfactory laser marking on a curvilinear or imperfect surface of the industrial product

In this embodiment, the imaging system 16 has a camera and an illumination projector in communication with an imaging reconstruction module. The illumination projector can be used to illuminate a plurality of patterns of structured light (can also be referred to as “moving pattern of structured light”) on the surface of the industrial product while the camera images the illuminated surface of the industrial product, which can yield a plurality of 2D image data sets. In this embodiment, the imaging reconstruction module has stored thereon an imaging reconstruction program which can reconstruct 3D image data from the plurality of 2D image data sets provided by the camera based on the known patterns of structured light. Such 3D image can be said to be “high resolution” (e.g. 5000 data points per 50 mm scanned, e.g. in all three axes). It will be understood that the 3D image is typically referenced in a reference coordinate system of the laser marker 14. In an embodiment, the reference coordinate system corresponds to the position of the focal spot of a focusing lens of the laser marker 14. The imaging reconstruction module can transmit the reconstructed 3D image data sets to the processor for subsequent storing on the memory of the system 10. In an embodiment, the imaging reconstruction program is stored on the memory such that the imaging reconstruction module can be provided in the form of the memory. In another embodiment, the imaging system 16 has two or more cameras and an illumination projector in communication with the imaging reconstruction module. In this specific embodiment, the illumination projector can be used to illuminate one or more patterns of structure light on the surface of the industrial product while the two or more cameras image the illuminated surface of the industrial product. This can yield a plurality of 2D image data sets that can be used to reconstruct a 3D image using the imaging reconstruction module of the imaging system 16.

It is understood that the positioning of the industrial product relative to the laser marker 14 may not be precise enough to allow the laser-marking surface 20 to be within the effective marking distance associated with the laser-marking beam when the laser marker 14 has a 2—axis scanner head (e.g. x- and y-axes). In this embodiment, providing a 3—axis scanner head can allow to move the focal spot towards the laser-marking surface 20 (e.g. in the z-axis) of the industrial product 12 to allow satisfactory laser marking of the laser-marking surface 20.

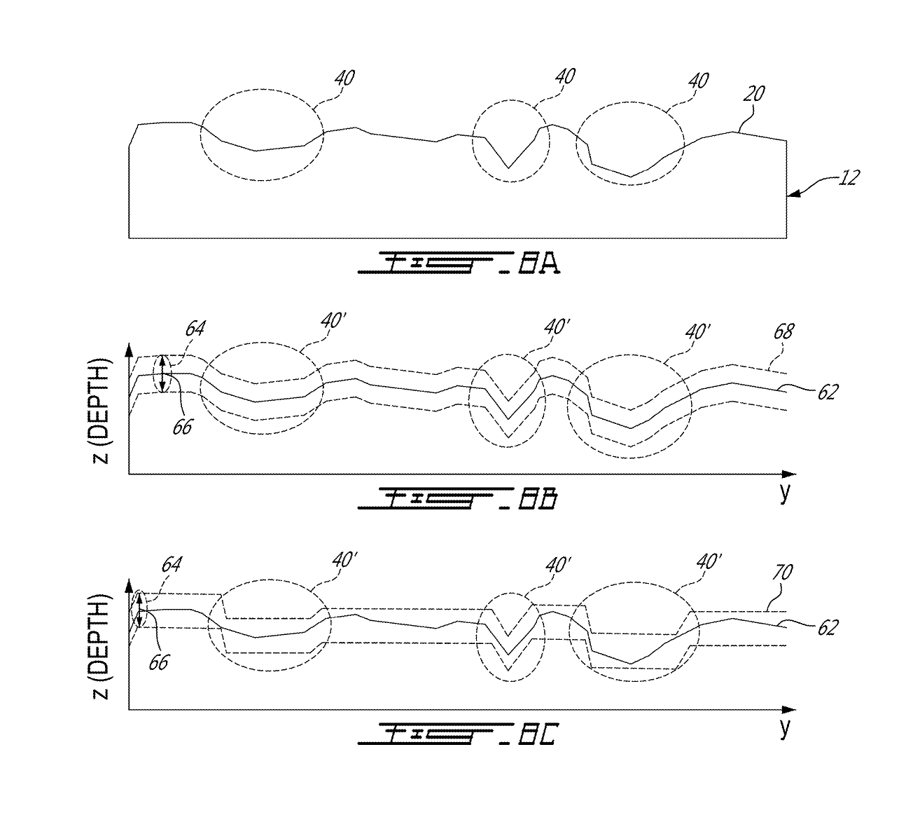

FIG. 8A shows a partial cross-section of a portion of the laser-marking surface 20 of the industrial product 12, in accordance with an embodiment. In this embodiment, the 3D image includes a surface profile of the laser-marking surface 20 of the industrial product 12. For instance, FIGS. 8B-C show surface profiles 62 of the cross-section of the laser-marking surface 20 of FIG. 8A as a function of a distance along the y-axis, for instance. In this embodiment, the laser marking of the identifier is based on the surface profile 62 of the laser-marking surface 20 of the industrial product 12. More specifically, the system 10 is used to move a laser-marking beam along a laser-marking path on the laser-marking surface 20 of the industrial product 12 while simultaneously moving a focal spot 64 of the laser-marking beam as a function of the surface profile 62 in a manner to maintain the focal spot 64 of the laser-marking beam in coincidence with the laser-marking surface 20 of the industrial product 12. It will be understood that the illustrated surface profiles 62 correspond to only a portion of the identifier which is to be laser marked on the laser-marking surface 20. Although this portion of the laser-marking path is shown to be directed along the y-axis, it is understood that the laser-marking path can be oriented in the x-axis, the y-axis, the z-axis, or any combination thereof, depending on the identifier and on the laser-marking surface 20 of the industrial product 12.

In an embodiment, the focal spot 64 has an effective working distance 66 such as shown in FIGS. 8B-C. The effective working distance 66 is typically referred to as the distance along the propagation direction of the laser-marking beam where the laser-marking beam suitably mark the laser-marking surface 20 of the industrial product 12. Differently put, the effective working distance 66 corresponds to the distance along the propagation direction of the laser-marking beam where the intensity of the laser-marking beam is higher than a threshold of the material to laser mark (effective marking threshold). When the intensity of the laser-marking beam is above such effective marking threshold, the laser-marking surface 20 can be satisfactorily laser marked. Practically, when the intensity of the laser-marking beam at the focal spot 64 is above the effective marking threshold and when the effective working distance 66 of the focal spot 64 coincides with the laser-marking surface 20 of the industrial product 12, suitable laser marking is likely to occur. In an embodiment, the speed of the laser-marking beam is adjusted so that the intensity delivered to a given portion of the laser-marking surface 20 by the laser-marking beam is equal or slightly greater than the effective marking threshold of the material to laser mark.

In an embodiment, the focal spot 64 is maintained at a constant depth relative to the surface profile 62 unless it is determined that the surface profile 62 varies by a depth greater than the effective working distance 64 of the laser-marking beam. In another embodiment, the accuracy at which the focal spot 64 is chosen to follow the surface profile 62 can depend on the embodiment. For instance, FIG. 8B shows a laser-marking path 68 which has a greater accuracy than the laser-marking path 70 shown in FIG. 8C. The accuracy and resolution of the system 10 will depend on the application.

In the illustrated embodiments, the laser-marking paths 68, 70 are shown to be continuous along the surface profile 62. In an embodiment, the identifier is discontinuous, i.e. there exists gaps between portions of the identifier to laser mark. In an embodiment, laser marking such discontinuous identifiers involves shutting off the laser-marking beam while the laser-marking beam is moved from one portion of the identifier to laser mark to another. In another embodiment, laser marking such discontinuous identifiers involves moving the focal spot away from the surface profile 62 as the laser-marking beam is moved from one portion of the identifier to laser mark to another.

In the embodiment shown, the laser marker 14 has a 3—axis scanner head which allows laser marking of the laser-marking surface 20 along three perpendicular axes (e.g. x, y and z). In an embodiment, the 3—axis scanner head can be of the type AXIALSCAN or of the type FOCUSSHIFTER as provided by the brand RAYLASE (see www.raylase.de for further detail). In another embodiment, the laser marker 14 has a 2—axis scanning head and the laser marker 14 is movably mounted to the frame 18. In this embodiment, the laser marker 14 can be moved such that the focal spot 64 can coincide with the surface profile 62. In another embodiment, the industrial product 12 is movable relative to the frame 18 such that the focal spot 64 can coincide with the surface profile 62. In an embodiment, the camera can be of brand Allied Vision™ and model Manta G-125B. In another embodiment, the illumination projector can be provided by Texas Instruments™ as the model #DLPLCR4500EVM.

FIG. 9 shows a detailed example of the system 10 for laser marking identifiers on industrial products. The system 10 involves the interaction of a plant managing system 72 of the production plant 100 such as shown in FIG. 1. The plant managing system 72 is generally associated with the production plant and can provide most of the information to be laser marked on each industrial product. The plant managing system 72 can associate a job to each one of the industrial products which are to be laser marked with different identifiers. Each job is transmitted from the plant managing system 72 towards the system 10 for processing by a controller 74, for instance. The controller 74 processes each job by suitable interaction with a scanner card 76 (e.g. USB scanner controller of brand SCAPS™) and computer software products such as an imaging software product 78, a main software product 80 comprising an image processing software product and optional 3D scanner application module(s) 82 (such as SAMLight™) in cases where the depth of the focal spot has to be adjusted to follow a surface profile. It is understood that the links between these components can vary depending on the circumstances.

Once the industrial products are identified and positioned in a reference coordinate system of the laser marker 14, the system 10 can laser mark each part in accordance with the methods described herein. More specifically, the industrial product to laser mark can be one part amongst a plurality of parts such that the methods and systems can identify the industrial product amongst the plurality of parts and associate the first area and the second area of the industrial product to given coordinates in the reference coordinate system of the laser marker 14. Once the part is identified, the systems can determine a “defect-free” portion associated with each of the parts for subsequent laser marking and/or the systems can factor in the surface profile associated with each of the parts when laser marking each industrial product. In this embodiment, the identifier that is laser marked on each part can be based on the recognition of the part amongst the plurality of parts.

In another embodiment, the systems and methods described herein can be used to identify, using computer vision, a given part of a plurality of assembled parts and to laser mark the identified given part subsequently. In an embodiment, the given part is a top portion of a valve and the plurality of parts is an assembled engine. Accordingly, in an envisaged embodiment, the systems and methods described here are used in the automotive industry in order to laser mark given pieces of engines as they are conveyed from one point to another during manufacture of the engine. Other suitable application of the systems and methods will be apparent to the skilled reader. In another embodiment, the plurality of parts can be a plurality of disassembled parts conveyed on a conveyor for instance.

As will be understood, the industrial product 12 can be made of any type of metal and/or can have any type of shape and size. The industrial product can be provided in the form of a sow, a billet, an ingot, a casting part or any part of an assembled system (e.g. a valve of an engine). It is thus understood that the system 10 is to be used in connection with the primary sector of the economy and/or parts manufacturing.

The laser marker 14 can be a standalone laser-marking subsystem which has a laser-beam generator for generating a laser-marking beam, one or more scanner heads (e.g. 3—axis scanner) which receive and redirect the laser-marking beam towards the surface of the industrial product and a scanner card (e.g. a USB scanner card) which receives laser-marking instructions from the processor and then executes the laser-marking instructions accordingly. For instance, the laser-beam generator can be provided in the form of a fiber laser emitting radiation of electromagnetic radiation having a wavelength of approximately 1064 nm. The scanner heads can be provided in the form of 2—axis scanner heads or in the form of 3—axis scanner heads, depending on the circumstances. Any type of suitable laser marker can also be used.

In an embodiment, the imaging system 16 has a camera having a charge-coupled device (CCD) sensor which is adapted to provide 2D image data of the surface of the industrial product 12. Alternately, the image data can be 3D image data when using stereoscopic vision (i.e. 3D vision) or structured light imaging. In some embodiments, the imaging system 16 can be provided with zoom capability. As will be understood, any type of suitable imaging system 16 can also be used.

As can be understood, the examples described above and illustrated are intended to be exemplary only. For clarity, it is understood that defects that have a minimal impact on laser marking are not considered to be defect in this specification. Accordingly, the identifier can be marked on a surface having such defects that are so small that the defects do not alter laser marking. As it will be apparent for the skilled reader, the size of such defects will vary in function of the size of the identifier and of the size of the focal spot. It is understood that the methods and systems described therein are not limited to laser marking of pieces of metal and that the methods and systems described therein can be used for laser marking pieces of plastic and other adequate pieces of material. As will be understood, this disclosure presents embodiments which are meant to be exemplary. Any suitable combination of these embodiments can be used. The scope is indicated by the appended claims.

1-18. (canceled)

19. A method for laser marking identifiers on industrial products in a production line of a production plant, the method comprising;
conveying a plurality of industrial products to form a flow of industrial products along the production line, the industrial products each having a laser-marking surface, a shape and a position of the laser-marking surface being irregular from one of the industrial products to another;
using a 3D imaging system, obtaining 3D image data indicative of the irregular shape and the irregular position of the laser-marking surface of a first one of the industrial products along the flow of industrial products;
obtaining identifier data representative of the identifier of the first industrial product;
using a laser marker, laser marking the identifier associated with the first industrial product on the laser-marking surface of the first industrial product by displacing a focal spot of a laser-marking beam of the laser marker along irregularities of the laser-marking surface based on the 3D image data and the identifier data; and
repeating the steps of obtaining and laser marking for other ones of the industrial products.

20. The method of claim 19, wherein the 3D imaging system is configured to illuminate the first industrial product with one or more known patterns of structured light with an illumination projector of the 3D imaging system, to image the illuminated industrial product using at least one camera of the 3D imaging system and to obtain the 3D image data based on the imaging of the illuminated industrial product using an image reconstruction module of the 3D imaging system.

21. The method of claim 19, wherein said laser marking further comprises maintaining the focal spot of the laser-marking beam at a constant depth relative to the laser-marking surface of the first industrial product upon determining that the irregular shape varies by a depth smaller than an effective working distance of the laser-marking beam.

22. The method of claim 19, further comprising, after said laser marking, reading the laser-marked identifier; validating that the laser-marked identifier is readable; and generating a signal based on said validation.

23. The method of claim 22, further comprising correcting the laser-marked identifier by laser marking corrections on the laser-marked identifier when the generated signal indicates that the identifier is unreadable.

24. The method of claim 19, wherein, during said laser marking, receiving additional information associated with the first industrial product, the method further comprising the step of laser marking the additional information on the laser-marking surface of the first industrial product.

25. The method of claim 24, wherein the additional information is a weight information indicating a weight of the first industrial product measured with a weight sensor disposed along the production line.

26. The method of claim 19, wherein the first industrial product is one part amongst a plurality of parts, the method further comprising identifying the first industrial product amongst the plurality of parts before laser marking the first industrial product.

27. The method of claim 26, wherein said obtaining and said laser marking are performed for each one of the plurality of parts.

28. The method of claim 19, wherein said laser marking further comprises laser marking the laser-marking surface of the first industrial product while the first industrial product is being conveyed along the production line.

29. The method of claim 19 further comprising configuring a power of the laser-marking beam based on a material of the first industrial product.

30. The method of claim 29, wherein the material of the first industrial product is metal.

31. The method of claim 19, wherein said identifier data are obtained from a plant managing system.

32. A system for laser marking identifiers on industrial products in a production line of a production plant, the system comprising:
a 3D imaging system and a laser marker disposed in the production line and oriented towards a flow of industrial products of the production line, each industrial product having a laser-marking surface having a shape and a position being irregular from one of the industrial products to another;
a processor in communication with the 3D imaging system and the laser marker, the processor being coupled with a computer-readable memory being configured for storing computer executable instructions that, when executed by the processor, perform the steps of:
obtaining 3D image data indicative of the irregular shape and the irregular position of the laser-marking surface of a first one of the industrial products of the flow of industrial products;
obtaining identifier data representative of the identifier of the first industrial product;
instructing the laser marker to laser mark the identifier associated with the first industrial product on the laser-marking surface of the first industrial product by displacing a focal spot of a laser-marking beam of the laser marker along irregularities of the laser-marking surface based on the 3D image data and the identifier data.

33. The system of claim 32, wherein the 3D imaging system has at least one camera, a light projector and an image reconstruction module and wherein the laser marker has a 3—axis scanning head.

34-61. (canceled)
